(19) United States
(12) Patent Application Publication
(10) Pub. No.: US 2011/0262583 A1
(43) Pub. Date: Oct. 27, 2011

(54) Mould with demoulding function

(75) Inventor: Wen-Hwa Lin, Taichung City (TW)

(73) Assignee: VP Components Co., Ltd.

(21) Appl. No.: 12/799,500

(22) Filed: Apr. 26, 2010

(51) Int. Cl. B29C 45/03

(52) U.S. Cl. 425/556

(57) ABSTRACT

A module with a demoulding function comprises a module member including a cavity for molding a molded part, the module member having an upper channel and a lower channel passing therethrough, each of the upper and the lower channels having a ramp, and the ramps of the upper and lower channels extending symmetrically and convergently; two sliding members movably received in the upper and lower channels, respectively; and two cores each attached to one end of a respective said sliding member and located in the cavity. In use, after an injection molding process, the cores form recesses on the molded part. Then the two sliding members are pushed toward the molded part. The convergent ramps lead the two sliding members to converge, so that when the molded part is departed from the cavity, the cores come off from the recesses of the molded part.

### BACKGROUND OF THE INVENTION

1. Technical Field

The present invention relates to molding modules, and more particularly, to a module with a demoulding function which facilitates the slide of cores with respect to a molded part and contributes to a convenient and quick demoulding process.

2. Description of Related Art

Conventionally, for the sake of cyclists' safety, bicycle pedals are attached with reflection stickers or provided with reflectors, which reflect incident light to alert surrounding road users in order to improve the safety of night riding.

Such a bicycle pedal is typically made through injection molding. During the process of injection molding, after a molded part is molded in a module, there is needed a demoulding mechanism to depart the molded part from the module. Therein, the intact condition of the molded part departed from the module highly depends on how the module is designed. Particularly, when the molded part has recesses on laterals thereof, the demoulding process is relatively complex. Taking a bicycle pedal provided with reflectors as mentioned in the previous paragraph for example, the molded pedal has a closed body with recesses at two laterals thereof for accommodating the reflectors. By the conventional approach, it is impossible to mold and demodule the pedal body and the reflectors simultaneously but necessary to wait for the accomplishment of the body's molding and demoulding and then place the reflectors separately molded in to the recesses at the laterals of the pedal body. Obviously, the above-described process that contains at least two processing procedures is time-consuming and effort-consuming, leading to inefficiency of the process.

### SUMMARY OF THE INVENTION

In view of the shortcomings of the prior-art approach as indicated previously, the present invention proposes a module with a demoulding function.

The present invention provides a module with a demoulding function. The mould including: a module member, having at least one cavity for allowing a molded part to be molded therein, an upper and a lower channel, each passing through the module member and having at least one ramp wherein the two ramps are symmetrical and convergent; two sliding members, movably received in the upper and lower channels, respectively; and two cores, each attached to one end of the corresponding sliding member.

In use, following steps are performed:
injecting a moldable material into the module member for such molding the molded part that the cores form recesses on the molded part; and
pushing the two sliding members to make the two sliding members slide in the upper and lower channels, respectively, toward the molded part, wherein the convergent ramps of the upper and lower channels lead the two sliding members to converge, so that when the molded part is departed from the cavity, the cores come off from the recesses of the molded part.

One objective of the present invention is to provide the above-mentioned module with the demoulding function, wherein the convergent ramps of the upper and lower channels lead the two sliding members to converge, thereby allowing the cores to easily and quickly depart from the molded part.

Another objective of the present invention is to provide the above-mentioned module with the demoulding function, wherein the cores formed with patterns endow the recesses of the molded part with patterned surfaces that act as reflective surfaces, so that the molded part and the reflective surfaces are integratedly formed in a single injection-molding process, thereby significantly saving process time and improving production efficiency as compared with the prior art.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of an illustrative embodiment when read in conjunction with the accompanying drawings, wherein:

FIG. 1 is a perspective view of part of two modules each having a demoulding function according to the present invention;

FIG. 2 is a schematic front view of the part of the module according to the present invention;

FIGS. 3 and 4 are schematic drawing showing operation of the demoulding function of the present invention; and

FIG. 5 is a schematic drawing illustrating the modules implemented on a molding machine.

### DETAILED DESCRIPTION OF THE INVENTION

While a preferred embodiment provided hereinafter for illustrating the concept of the present invention as described above, it is to be understood that the components of the embodiment shown in the accompanying drawings are depicted for the sake of easy explanation and need not to be made in scale.

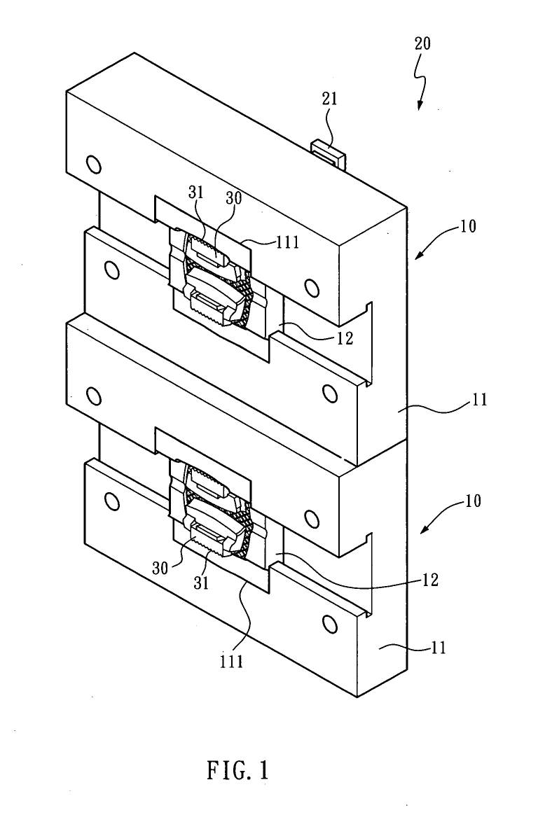

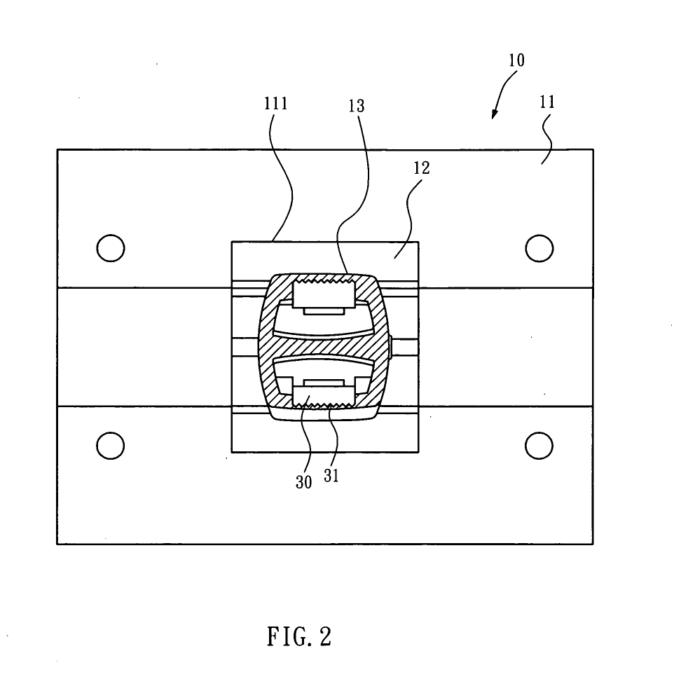

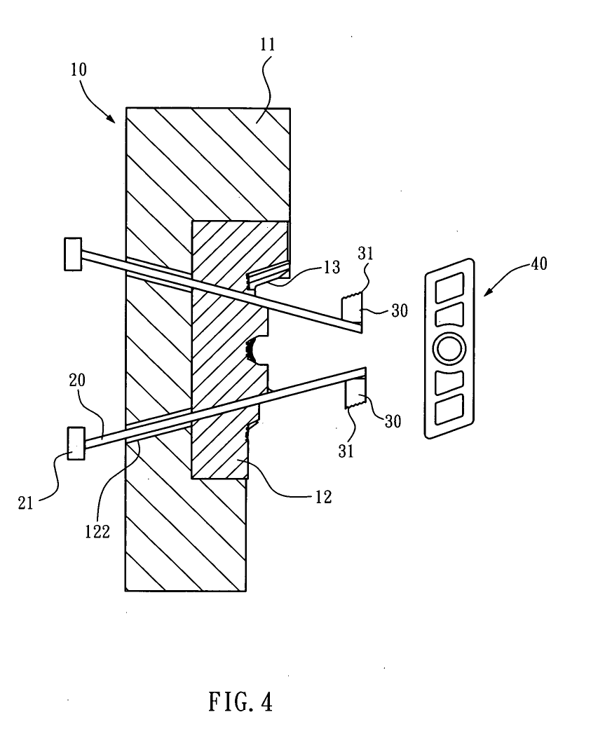

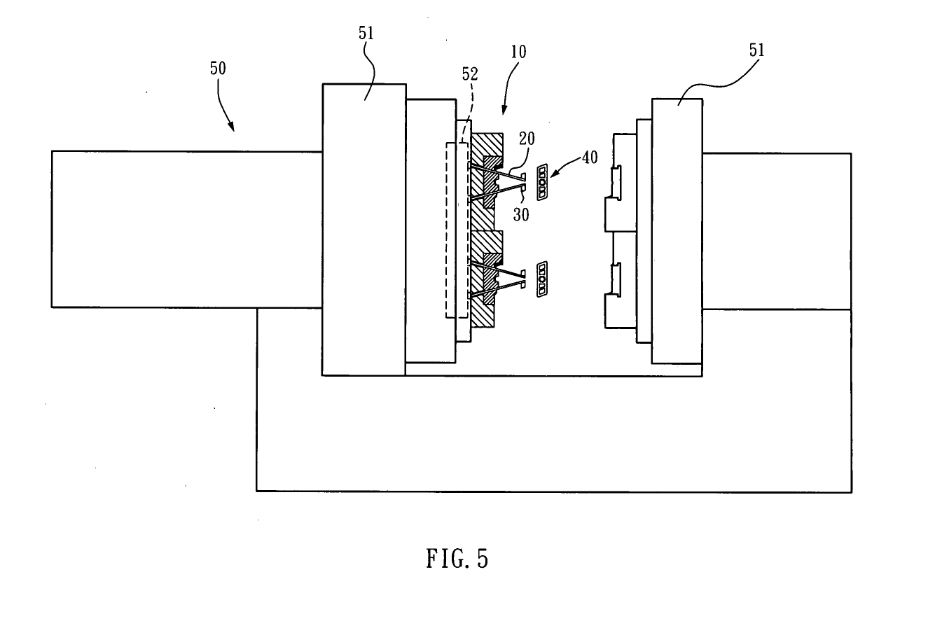

The present invention provides a module with a demoulding function. While FIG. 1 shows part of two said modules aligned together and FIG. 2 depicts only part of one said module for brevity's sake, it is to be noted that another half part of each said module as shown in FIG. 5 is relatively irrelevant to the demoulding function and known to people skilled in the art, so is omitted in FIGS. 1 through 4. Referring to FIGS. 1 and 2, the closed mould includes at least a module member 10, two sliding members 20, and two cores 30.

The module member 10 includes a module seat 11 and a module body 12. The module seat 11 has a socket 111 for receiving the module body 12 removably inlaid therein. Therein the module body 12 can be replaced with another one having a different shape when a different molded part is desired. Despite the module member 10 shown herein, the module member 10 may alternatively have the module seat 11 and the module body 12 integratedly formed or fixed coupled, without limitation.

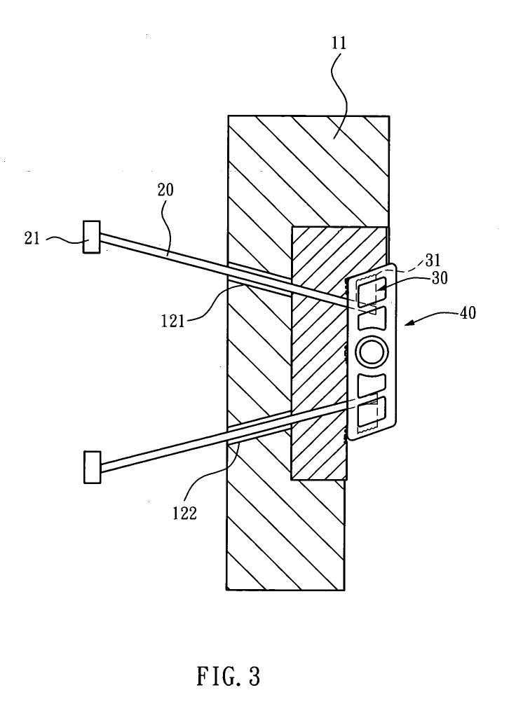

Referring to FIG. 2 through FIG. 4, the module member 10 has at least one cavity 13 for allowing a moldable material to be poured therein and formed as a molded part 40. In the present embodiment, the molded part 40 is designed to be a bicycle pedal. The module body 12, as can be seen in FIG. 3, has an upper channel 121 and a lower channel 122 passing therethrough. Each of the upper channel 121 and the lower channel 122 has at least one ramp extending toward a center of the module member 10. The ramps of the upper channel 121 and the lower channel 122 are thus symmetrical and convergent.

The two sliding members 20 are movably received in the upper channel 121 and the lower channel 122. Therein, the sliding members 20 are sticks, rods or of other applicable shapes. Due to the ramps provided in the upper channel 121 and the lower channel 122, the two sliding members 20 settled in the upper channel 121 and the lower channel 122 are posed symmetrically and convergently toward an invisible convergent point corresponding to the molded part 40.

As shown in FIG. 1 through FIG. 4, each of the two cores 30 are connected beside an end of a corresponding said sliding member 20. The cores 30 each have a surface opposite to another surface facing the center of the module member 10 formed with a pattern 31. The sliding members 20 each have a pushing block 21 arranged at an end thereof opposite to the end having the core 30. The pushing block 21 may be in the shape of a rectangular block. When the two sliding members 20 are placed in the upper channel 121 and the lower channel 122, respectively, the two core 30 are presented at openings of the upper channel 121 and the lower channel 122, respectively, while the pushing blocks 21 is presented at a back side of the module seat 11 opposite to a front side having the socket 111.

Basing on the aforementioned configuration, the demoulding function of the module is performed as described below.

Referring to FIG. 2, the moldable material is injected into the cavity 13 (as the part with slashes in the drawing) for filling the module body 12. After the moldable material is cured in the module body 12, the molded part 40 is obtained. At this time, the cores 30 are located at recesses on two inner lateral walls of the molded part 40, and the patterns 31 have endowed surfaces of the recesses of the molded part 40 with the patterns, namely forming them as patterned, reflective surfaces. Consequently, the molded part 40 and the reflective surfaces are made as a whole.

Afterward, the demoulding process is to be undertaken. Referring to FIG. 5, which shows two of the disclosed modules implemented on a plastic injection molding machine 50. The plastic injection molding machine 50 has two opposite closing devices 51, wherein one of the closing devices 51 is provided with an ejection board 52 for being corresponding to the pushing blocks 21 of the sliding members 20. In the demoulding process, the two closing devices 51 separate and the ejection board 52 is pushed to prop up the pushing blocks 21, so as to make the sliding members 20 of each said module member 10 moving in the upper channel 121 and the lower channel 122 toward the molded part 40 until the pushing blocks 21 closely contact the module seat 11. At this time, the convergent ramps of the upper channel 121 and the lower channel 122 lead the two sliding members 20 to approach each other. Thereby, the molded part 40 can easily be taken out from the module member 10 because the cores 30 easily depart from the recesses of the molded part 40.

The present invention has been described with reference to the preferred embodiment and it is understood that the embodiment is not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A module with a demoulding function, the module comprising:
at least one module member, each including at least a cavity for molding a moldable material into a molded part through an injection-molding process, at lest one of the module member having an upper channel and a lower channel passing therethrough, each of the upper channel and the lower channel having at least one ramp, and the ramps of the upper and lower channels extending symmetrically and convergently toward an invisible convergent point corresponding to the molded part;
two sliding members movably received in the upper and lower channels, respectively; and
two cores, each attached to one end of a respective said sliding member and located in the cavity.

2. The mould as claimed in claim 1, wherein each of the cores has a surface formed with a pattern and the surface formed with the pattern is opposite to another surface of the core that is relatively close to the convergent point.

3. The mould as claimed in claim 2, wherein the patterns of the cores endow the molded part with patterned surfaces that act as reflective surfaces.

4. The mould as claimed in claim 1, wherein each of the sliding members has a pushing block provided at an end opposite to the end having the core and each of the pushing blocks is a rectangular block.

5. The mould as claimed in claim 1, wherein the module member includes a module seat and a module body, and the module seat has a socket for receiving the module body.

6. The mould as claimed in claim 5, wherein the module body is removably inlaid in the socket.

7. The mould as claimed in claim 5, wherein the module seat and the module body are formed integratedly.

8. The mould as claimed in claim 1, wherein the molded part is a bicycle pedal.

9. The mould as claimed in claim 1, wherein each of the sliding members is a stick or a rod.
